(19) United States
(12) Patent Application Publication
(10) Pub. No.: US 2005/0174455 A1
(43) Pub. Date: Aug. 11, 2005

(54) Column amplifier for image sensors

(75) Inventors: Yair Elmakias, Givat Olga (IL); Vadim Gelfand, Ramat-Gan (IL); Alex Shnayder, Zichron-Ya'acov (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: TransChip, Inc., Ramat - Gan (IL)

(21) Appl. No.: 11/046,194

(22) Filed: Jan. 27, 2005

Related U.S. Application Data
(60) Provisional application No. 60/539,616, filed on Jan. 27, 2004.

(51) Int. Cl. H04N 5/335

(52) U.S. Cl. 348/308

(57) ABSTRACT

Embodiments of the present invention provide for reducing leakage associated with hold capacitors used in the processing of analog outputs from an image sensor. In some embodiments, a circuit configuration provides for load balancing of a hold capacitor associated with the image processor to prevent voltage droop across the storage capacitor. In certain embodiments, double sampling of the image sensor is provided for and two hold capacitors are configured to have balanced loads across each of the capacitor's terminals so as to prevent associated voltage droop. In embodiments of the present invention, a discharge mechanism associated with the hold capacitors is configured to only connect to the hold capacitor during discharge, in order to prevent leakage from the capacitor. In certain embodiments of the present invention, load balancing of the hold capacitors may be achieved by using symmetrical circuit design and circuit layout. Embodiments of the present invention may provide for minimum leakage of the hold capacitors and low noise operation of the image sensor.

### BACKGROUND OF THE INVENTION

This application claims the benefit of and is a non-provisional of U.S. Application Ser. No. 60/539,616 filed on Jan. 27, 2004, which is incorporated by reference in its entirety for all purposes.

### BRIEF DESCRIPTION OF THE DRAWINGS

The present disclosure is described in conjunction with the appended figures:

FIG. 1 illustrates a block diagram of an imaging device, in accordance with various embodiments of the present invention;

FIG. 2 illustrates a first part of a sample and hold circuit, in accordance with various embodiments of the present invention;

FIG. 3 illustrates a dual sample and hold circuit, in accordance with various embodiments of the present invention;

FIG. 4 illustrates a second part of a sample and hold circuit with discharge mechanism, in accordance with various embodiments of the present invention;

FIG. 5 illustrates multiplexing outputs from a plurality of sample and hold circuits, in accordance with various embodiments of the present invention.

FIG. 6 illustrates a circuit for amplifying and digital converting an output from a sample and hold circuit, in accordance with various embodiments of the present invention; and

FIG. 7 illustrates timing waveforms of the main control signals of an image sensor device, in accordance with various embodiments of the present invention.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

Embodiments of the present invention relate in general to methods and systems for processing outputs from image sensors, including the amplification and analog to digital conversion of signals produced by an image sensor. More specifically, but not by way of limitation, embodiments of the present invention concern the storage of an analog signal from an image sensor on a sample and hold circuit and the processing and amplification of the signal prior to the digital conversion of the signal.

An image sensor may be a two-dimensional array of pixels and the pixels on the array may be considered as rows and columns. Outputs from the pixels may be applied to circuits and processed to produce an output signal from the image sensor. In certain aspects, circuits may provide for the amplification and analog to digital conversion of the signals produced by the pixels. Typically, a pixel produces an output voltage. As generally known in the relevant art and for purposes of this specification, the set of circuits used to process pixel signals that is connected to the columns of an image sensor array is referred to as a “column amplifier.” Embodiments of this invention may concern column amplifiers and column amplification of signals produced by an image sensor. However, embodiments of the present invention may be used in other image sensor amplification and/or analog to digital conversion circuits other than column amplifiers. As discussed in this specification, the column amplifier may comprise sample and hold circuits, analog multiplexers, operational amplifiers, and the like.

Embodiments of the present invention may be used with any type of image sensor, e.g., a charge coupled device (“CCD”) or a complementary metal oxide semiconductor (“CMOS”) image sensor. Operation of a CMOS image sensor is discussed in U.S. Pat. No. 6,035,077, “SINGLE-CHIP COLOR CMOS IMAGE SENSOR WITH TWO OR MORE LINE READING STRUCTURE AND HIGH-SENSITIVITY INTERLACE COLOR STRUCTURE,” to Chen et al., that is incorporated by reference in its entirety for all purposes. Generally, image sensors incorporate on-chip analog processing of the light-induced charge in each pixel. As described in U.S. Pat. No. 6,124,819, “CHARGE INTEGRATION SUCCESSIVE APPROXIMATION ANALOG-TO-DIGITAL CONVERTER FOR FOCAL PLANE APPLICATIONS USING A SINGLE AMPLIFIER,” to Zhou et al, that is incorporated by reference in its entirety for all purposes, there is an engineering tradeoff between the number of analog to digital converters and the complexity and size of the imager device, e.g., the more analog top digital converters the more complex the imager device. The range of this tradeoff spans from one analog to digital converter (“ADC”) for each pixel in one extreme, to a single ADC for the all of the pixels on the image sensor. In the latter situation, it is necessary to provide for analog multiplexing of all pixel units to the aforementioned single ADC.

In general, most image sensor devices take an intermediate approach. For example, each pixel may be connected by a circuit to a primitive one transistor amplifier. In such an image sensor device, the output of a row of pixels on the image sensor is read in parallel to a plurality of column amplifiers and the analog voltages, representing the light-induced charge at each pixel, are converted to digital form by one or more ADCs. Because, in such devices, multiple pixel outputs are being converted through the same ADC, pixel columns are sampled into a plurality of sample and hold circuits where the pixel outputs are stored until the ADC is ready to convert the analog signals to a digital form. In such devices, the plurality of sample and hold circuits may be connected to a plurality of amplifiers that, in turn, connect to a single or to a plurality of ADCs. The greater the number of ADCs the more complicated the image sensor device.

When the number of ADCs is smaller than the number of sample and hold circuits, analog to digital conversion may be done serially for several pixels. In the situation where analog pixel outputs are stored and then converted to digital signals, for accuracy reasons, the output from the sample and hold circuit should, ideally, correspond to the signal input to the sample and hold circuit from a pixel. Consequently, the sample and hold circuit should be able to hold the analog value to be converted with a minimum of leakage, even though it may take some time until the analog value is converted to a digital form. Because sample and hold circuits store the analog value on a capacitor and because capacitors associated with semiconductor devices leak, a drop in the analog signal over the time it is stored will occur. This drop in the stored analog value prior to analog to digital conversion presents a problem in image sensor sample and hold circuits. Moreover, due to the variation of process parameters and to uneven thermal distribution across the image sensor chip, the amount of the drop in the analog signal is not necessarily equal for each of an image sensor's sample and hold circuits. As a consequence, the drop in the analog signals stored in the sample and hold circuits associated with the image sensor will very often cause vertical noise stripes in the image produced by the image sensor.

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It is understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures and techniques may be shown without unnecessary detail in order to avoid obscuring the embodiments.

Also, it is noted that the embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

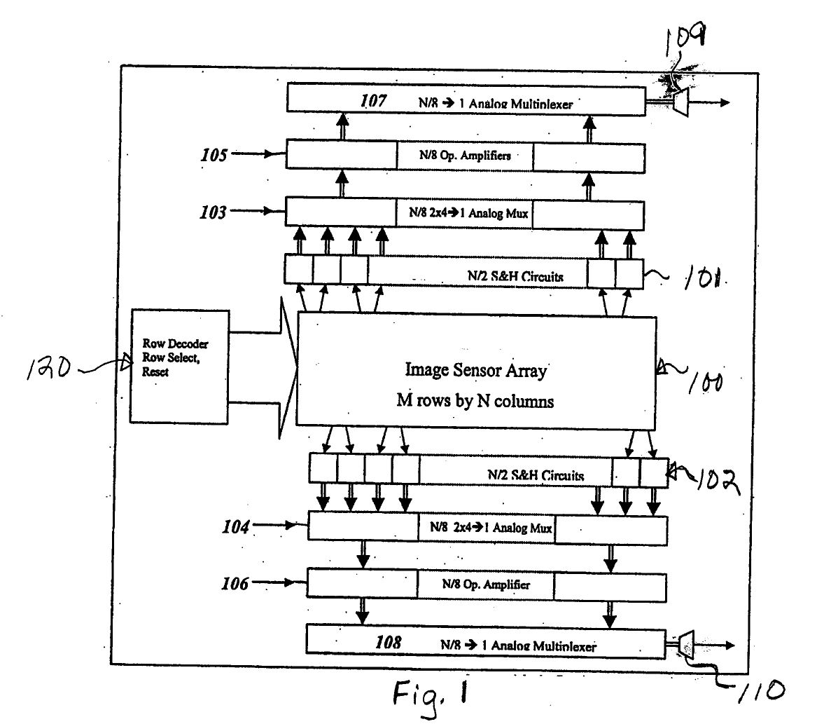

FIG. 1 illustrates a block diagram of an imaging device, in accordance with various embodiments of the present invention. As illustrated, in various embodiments of the present invention, image sensor array 100 may comprise M×N light-sensitive elements (that may be referred to as light-sensitive elements and/or pixels for purposes of this specification) arranged as a rectangular matrix having M horizontal rows and N vertical columns. In certain aspects, image sensor array 100 may be driven by row decoder 120 that may drive M horizontal row select lines and M horizontal row reset lines that, in turn, may drive N vertical pixel lines, that may be referred to herein as Vₚᵢₓ. In a single frame and/or single exposure, an image may be produced from the image sensor by the row decoder 120 driving the M horizontal row select lines and the M horizontal row reset lines.

Each light-sensitive element in image sensor array 100 integrates the luminance sensed at the geometrical location of that element and transforms it to a voltage level, herein referred to as Vₚ. The structure and elements of the image sensor array 100 are well-known in the art and, therefore, are not described.

In various embodiments of the present invention, when row decoder 120 sends a reset signal, a horizontal row reset is activated and all the light-sensitive elements on the selected horizontal row of the array may be reset to an initial value. In such embodiments, at reset, the output Vₚ from the light-sensitive elements is V_{ref}, where V_{ref} is the output of a light sensitive element under reset. In certain embodiments of the present invention, when the row decoder 120 sends a row select signal, a selected horizontal row may be activated and each element of that row will drive the corresponding vertical Vₚᵢₓ line with a voltage Vₚ, where Vₚ is the voltage produced by the light-sensitive element when illuminated by the image. In embodiments of the present invention, since the row select line drives all image elements of that particular row, all elements of the row drive their corresponding Vₚᵢₓ lines at the same time. In certain embodiments, a select output, Vₚ, and a reset output, V_{ref}, may be produced by each light-sensitive element to provide for a determination of a change in output by the light-sensitive element when it is illuminated by the image compared to its output at reset.

In certain embodiments, as discussed above, row select and row reset signals may be generated by row decoder 120. In certain aspects, a row select line may be driven when a corresponding row of the light-sensitive elements of the image sensor array 100 are scanned. In some embodiments of the present invention, the row select lines for each of the rows of light sensitive elements may be driven twice during the scan time of one frame. In these embodiments, the Vₚᵢₓ values of each row may be sampled twice to allow for double sampling of the light-sensitive elements. In some embodiments of the present invention, the row reset lines that may be produced by the row decoder 120 to reset the Vₚ levels of the light-sensitive elements in the image array may also be double sampled and driven twice per frame. In certain embodiments of the present invention, such double sampling may be performed to mitigate the parasitic effects of the reset control on Vₚ by subtracting the value of Vₚ after reset from its value at the end of the exposure period.

In various embodiments, the columns of image array 100 may be sampled in two sets of sample and hold circuits, a first set of sample and hold circuits 101 and a second set of sample and hold circuits 102. In certain embodiments, the first set of sample and hold circuits 101 and the second set of sample and hold circuits 102 may each comprise N/2 dual-sample and hold circuits (where N, as described above, is the number of columns of pixels on the image sensor array 100), each of which samples and holds the value of a single Vₚᵢₓ line at two time instances—after the light sensitive element is exposed and after a reset signal is applied to the light-sensitive elements.

In FIG. 1, the outputs from the two sets of sample and hold circuits 101 and 102 are designated by double arrows because in certain embodiments of the present invention each of the outputs may consist of two values that may be stored on two capacitors (not shown) in each single sample and hold circuit (not shown) that makes up the sets of sample and hold circuits 101 and 102. The sample and hold circuits making up the sets of sample and hold circuits and the capacitors in the circuits are more fully described below. In some embodiments, one of the two capacitors in each of the sample and hold circuits making up the sets of sample and hold circuits 101 and 103 may be used to store a value of Vₚᵢₓ after the exposure of light-sensitive elements on the image sensor array 100. This value of Vₚᵢₓ is referred to as smpᵢ. In some embodiments, one of the two capacitors in each of the sample and hold circuits making up the sets of sample and hold circuits 101 and 103 may be used to store a value of Vₚᵢₓ after a reset signal is applied by row decoder 200. This value of Vₚᵢₓ is referred to as refᵢ. In certain embodiments, each of smpiᵢ and refᵢ comprise a pair of signals that may be applied to the two capacitors of the sample and hold circuit. One of the pair of signals may be the actual sampled voltage, Vₚᵢₓ and the other may be the voltage at a common terminal of the capacitor. The voltage at the common terminal of the capacitors in the sample and hold circuits is referred to as cvcom.

In some embodiments of the present invention, the outputs from the first set of sample and hold circuits 101 and the second set of sample and hold circuits 102 connect, respectively, to a first set of analog multiplexers 103 and a second set of analog multiplexers 104. In certain embodiments, the first set of analog multiplexers 103 and the second set of analog multiplexers 104. In certain aspects, each of the analog multiplexers 103 and 104 may comprise N/8 dual 4→1 analog multiplexers. In various embodiments, each of the analog multiplexers in the first set of analog multiplexers 103 and the second set of analog multiplexers 104 may scan its four inputs and connect the scanned input to the next stage. In some embodiments of the present invention, the next stage comprises a first set of operational amplifiers 105 and a second set of operational amplifiers 106. In certain aspects, the first set of operational amplifiers 105 and the second set of operational amplifiers 106 each comprise N/8 pairs of operational amplifiers. In certain aspects of the present invention, one of the pairs of the operational amplifiers may amplify the voltage difference (smpᵢ-cvcom) and the other operational amplifier in the pair may amplify the voltage difference of (refᵢ-cvcom).

In certain embodiments of the present invention, the outputs from the first set of operational amplifiers 105 and the second set of operational amplifiers 106 connect to a first set of N/8 analog multiplexers 107 and a second set of N/8 analog multiplexers 108. In some embodiments of the present invention, each multiplexer of the first set of N/8 analog multiplexers 107 and the second set of N/8 analog multiplexers may multiplex a pair of the N/8 smpᵢ signals and the N/8 refᵢ signals and may connect one of the pairs at a time to a first analog to digital converter 109 and a second analog to digital converter 110. In this way, an output from each light-sensitive element of the image sensor array 100, where the output from the light-sensitive element is smpᵢ-refᵢ, may be converted from an analog signal to a digital signal.

The embodiments of the present invention illustrated in FIG. 1 and described above provide for an image sensor device comprising one image sensor, with M rows an N columns of light-sensitive elements, N sample and hold circuits, N/4 analog multiplexers, N/4 operational amplifiers, a second set of N/4 analog multiplexers and two analog to digital converters. In other embodiments, different numbers and different ratios of sample and hold circuits, analog multiplexers, operational amplifiers and analog to digital converters may be used.

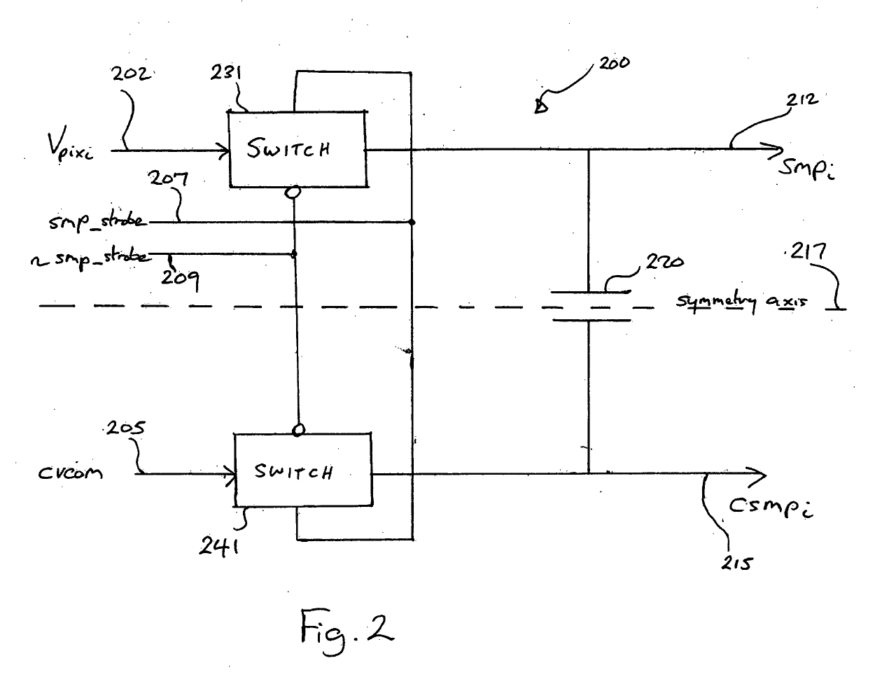

In FIG. 2, a first part of a sample and hold circuit 200 in accordance with various embodiments of the present invention is illustrated. In embodiments of the present invention, an output Vₚᵢₓᵢ 202 from a light-sensitive element of the image array sensor 100 may be applied to switch 231. In certain aspects, switch 231 comprises an N-channel transistor in parallel with a P-channel transistor. In certain embodiments, a common voltage cvcom 205 may be applied to switch 241. In some embodiments, switch 241 comprises an N-channel transistor in parallel with a P-channel transistor. In certain embodiments, switches 231 and 241 comprise and/or may be components of a multiplexer. In certain embodiments, capacitor 220 may be connected between the switches 231 and 241. In certain aspects, complementary control signals smp_strobe and ˜smp_strobe 207 may be used to control switches 231 and 241.

In some embodiments, when the strobe control signal smp_strobe is active, capacitor 120 may be connected to the Vₚᵢₓᵢ 202 output from the image array sensor 100 in its positive terminal and to the common voltage source cvcom in its negative terminal. In certain embodiments of the present invention, the capacitors may be non-polar, and therefore, the reference to positive and negative terminals is for convenience only. In embodiments of the present invention, when the strobe control signal is off, switches 231 and 241 may be closed and the voltage differential between the output Vₚᵢₓᵢ 202 and the common voltage cvcom 205 may be stored on the capacitor. In different aspects, after storage on the capacitor an output smpi 212 from the positive terminal of the capacitor 220 capacitor and an output csmpi from the negative terminal of the capacitor may be output from the storage and hold circuit for further processing. In certain aspects, the second half of the sample and hold circuit described below may control aspects of the output from capacitor 220.

In various dual sampling embodiments of the present invention, an smp_strobe signal may be activated after the exposure period for capacitor 220 to provide for storage of a second signal on the capacitor 220 during the image frame. In certain embodiments of the present invention, the plates of the capacitor 220 and the positions of the switches 231 and 241 may be arranged so that the sample and hold circuit may be arranged symmetrically around a symmetrical axis 217. In certain aspects, this symmetrical arrangement may provide for matching the loads on the terminals of capacitor 220. Although FIG. 2 shows a positional symmetrical arrangement of the capacitor 220 and the switches 231 and 241, in certain embodiments, the components may not be arranged physically symmetrically about symmetry axis 217, but the components of the sample and hold circuit may be arranged so as to have symmetry of electrical properties to provide for matched loads on the two plates of the capacitor 220.

In various embodiments of the present invention, the electrical components of circuit 200 may provide that the reverse voltage across the capacitor 220 is much larger than the thermal voltage associated with the capacitor 220. In some embodiments, the loads on the terminals of the capacitor 220 may be matched. In certain embodiments of the present invention, the loads on the terminals of the capacitor 220 may be matched and the reverse voltage across the capacitor 220 may be made to be much larger than the thermal voltage associated with the capacitor 220. In certain embodiments, the loads on the terminal of the capacitor 220 may be matched by symmetrically arranging the components of the circuit associated with the capacitor 220 symmetrically around the capacitor 220 and providing that components on either side of the capacitor have matching electrical properties. In some embodiments, a symmetrical arrangement may not be used, but instead the electrical properties of the components connected to a first terminal of the capacitor 220 may be matched to the electrical properties of the components connected to a second terminal of the capacitor 220. In certain embodiments, the terminals of the capacitor 220 may not be identical, and matching of the loads connected to the terminals may be provided for by taking account of differences between the terminals. In other embodiments, the loads on the terminals of the capacitor 220 may not be matched and the properties of the terminals may be adjusted to take into account differences in the loads.

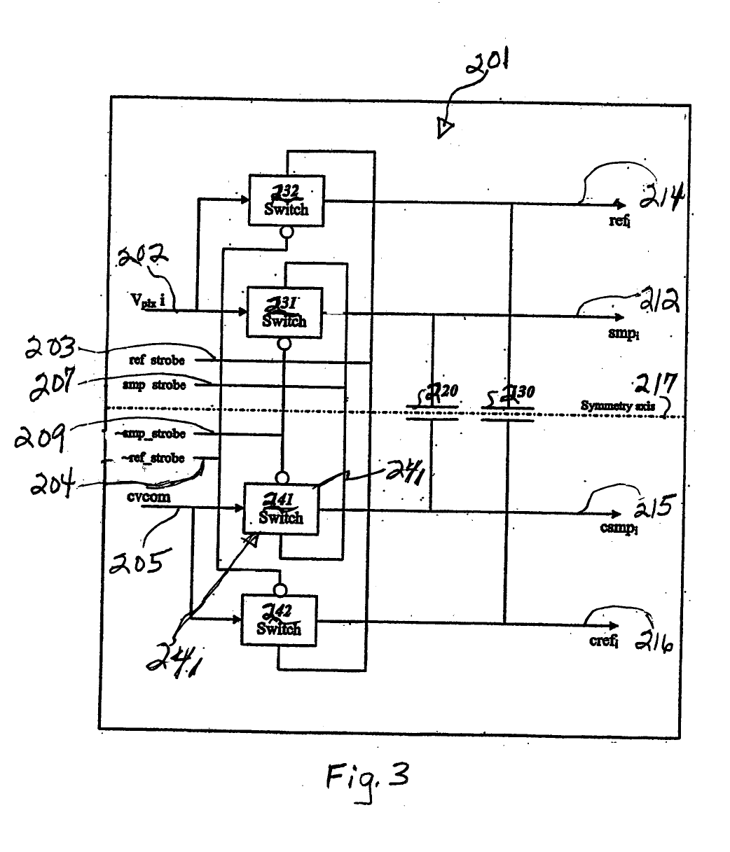

FIG. 3 illustrates a dual sample and hold circuit 201, in accordance with various embodiments of the present invention. In certain aspects, the dual sample and hold circuit 201 provides two capacitors for storing the output smpᵢ from a pixel of the image sensor array 100 illuminated by an image and the output refᵢ from the same pixel under reset. In various embodiments, the dual sample and hold circuit comprises a second capacitor 230 in addition to the capacitor 220. In embodiments of the present invention, the output Vₚᵢₓᵢ 202 from a light-sensitive element of the image array sensor 100 may be applied to the switch 231 and to a second switch 232. In certain aspects, the switch 232 comprises an N-channel transistor in parallel with a P-channel transistor. In certain embodiments, the common voltage cvcom 205 may be applied to the switch 241 and to a fourth switch 242. In some embodiments, switch 242 comprises an N-channel transistor in parallel with a P-channel transistor. In certain embodiments, switches 231, 232, 241 and 242 comprise and/or may be components of a multiplexer. In certain embodiments, the capacitor 230 may be connected between the switches 232 and 242. In certain aspects, control signals smp_strobe 207 and ˜smp_strobe 209 may be used to control switches 231 and 241 and control signals ref strobe 203 and ˜ref_strobe 204 may be used to control switches 232 and 242. In certain aspects, the smp_strobe signal 207 may be activated shortly after the exposure period for capacitor 220 and the ref_strobe signal 203 may be activated shortly after reset for capacitor 230.

In some embodiments, when the strobe control signal smp_strobe is active, capacitor 120 may be connected to the Vₚᵢₓᵢ 202 output from the image array sensor 100 in its positive terminal and to the common voltage source cvcom in its negative terminal. In some embodiments, when the strobe control signal ref_strobe is active, capacitor 120 may be connected to the Vₚᵢₓᵢ 202 output from the image array sensor 100 in its positive terminal and to the common voltage source cvcom in its negative terminal. In certain aspects, when smp_strobe signal 207 is active the output from the light-sensitive element of image sensor array 100 under incident illumination may be outputted through switch 231 to the positive terminal of the capacitor 220. In certain aspects, when ref_strobe signal 203 is active the output from the light-sensitive element of image sensor array 100 under reset may be outputted through switch 232 to the positive terminal of the capacitor 230.

In embodiments of the present invention, when the strobe control signal is off, switches 231, 232, 241 and 242 may be closed and the voltage differential between the output Vₚᵢₓᵢ 202 and the common voltage cvcom 205, when the sensing element is illuminated and under reset, respectively, may be stored on the two capacitors 220 and 230. In different aspects, after storage on the capacitor the output smpi 212 from the positive terminal of the capacitor 220 capacitor and the output csmpi from the negative terminal of the capacitor may be output from a first part of the dual storage and hold circuit for further processing. Similarly, in certain aspects, after storage on the capacitor the output refᵢ 214 from the positive terminal of the capacitor 230 capacitor and the output crefᵢ from the negative terminal of the capacitor may be output from the second part of the dual storage and hold circuit for further processing.

In various dual sampling embodiments of the present invention, the smp_strobe signal 207 may be activated after the exposure period for capacitor 220. In various dual sampling embodiments of the present invention, the ˜ref_strobe signal 204 may be activated shortly after reset for capacitor 230. In certain embodiments of the present invention, the plates of the capacitors 220 and 230 and the positions of the switches 231, 232, 241 and 242 and any other components in the circuit may be arranged so that the dual sample and hold circuit 201 is arranged symmetrically around the symmetrical axis 217. Although FIG. 2 shows a symmetrical arrangement, in certain embodiments, the components of the circuit may not be arranged physically symmetrically about symmetry axis 217, but the components of the dual sample and hold circuit 201 may be arranged so as to have symmetry of electrical properties to provide for equal loads on the two plates of each of the capacitors 220 and 230.

In various embodiments of the present invention, the electrical components of circuit 201 may be to provide that the reverse voltage across the capacitor 220 is much larger than the thermal voltages associated with the capacitors 220 and 230. In some embodiments, the loads on the terminals of the capacitor 220 and the loads on the terminals of the capacitor may be matched. In certain embodiments of the present invention, the loads on the terminals of the two capacitors 220 and 230 may be matched and the reverse voltage across the two capacitors 220 and 230 may be made to be much larger than the thermal voltage associated with the two capacitors 220 and 230. In certain embodiments, the loads on the terminals of the capacitor 220 and the loads on the terminals of the capacitor 230 may be matched by symmetrically arranging the components of the circuits associated with the two capacitor 220 and 230 symmetrically around each of the capacitors 220 and 230 and providing that components on either side of the capacitors 220 and 230 have matching electrical properties. In some embodiments, a symmetrical arrangement may not be used, but instead the electrical properties of the components connected to a first terminal of the capacitor 220 may be matched to the electrical properties of the components connected to a second terminal of the capacitor 220. Similarly, in some embodiments, a symmetrical arrangement may not be used with capacitor 230, but instead the electrical properties of the components connected to a first terminal of the capacitor 230 may be matched to the electrical properties of the components connected to a second terminal of the capacitor 230. In certain embodiments, the terminals of the capacitor 220 and the terminals of the capacitor 230 may not be identical, and matching of the loads connected to the terminals may be provided for by taking account of the differences in the characteristics of the terminals. In other embodiments, the loads on the terminals of the capacitor 220 may not be matched and the properties of the terminals of the capacitor 230 may be adjusted to take into account differences in the loads. Similarly, in some embodiments, the loads on the terminals of the capacitor 230 may not be matched and the properties of the terminals of the capacitor 230 may be adjusted to take into account differences in the loads.

In various embodiments of the present invention, electrical components and schematics may be arranged to provide that the reverse voltage across the capacitors may be much larger than any thermal voltage. In various embodiments, by matching the loads on the terminals of each of the capacitors 220 and 230 and providing that the reverse voltage across the capacitors may be much larger than any thermal voltage, the embodiments of the present invention provide that the leakage current from the terminals of the capacitors 220 and 230 may be very small.

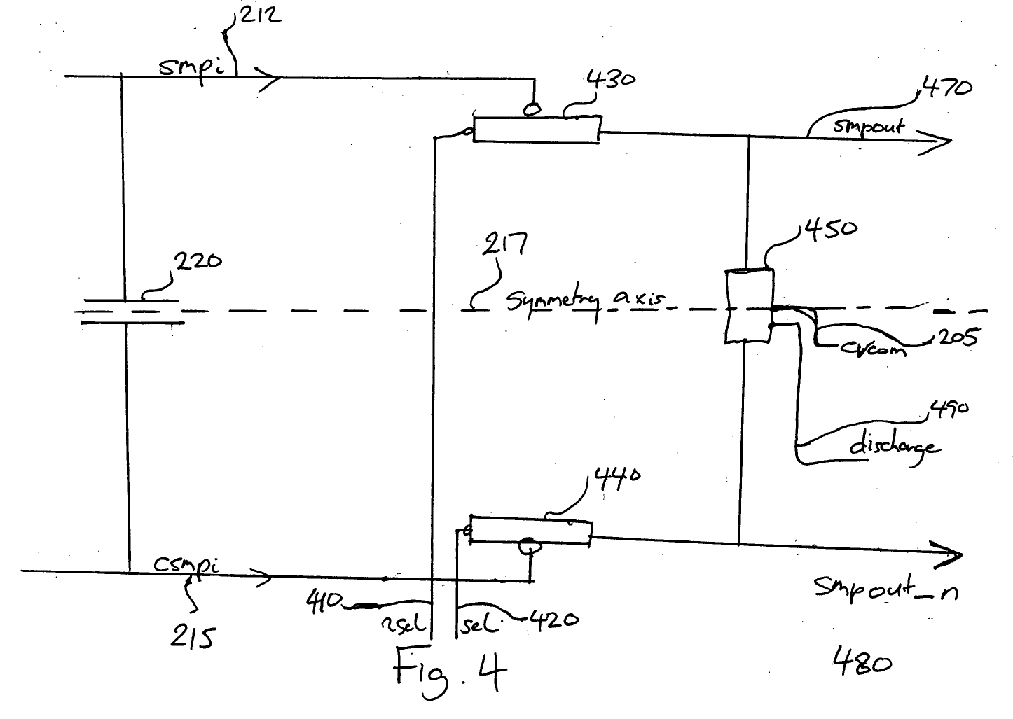

FIG. 4 illustrates a second part of a sample and hold circuit including a discharge mechanism, in accordance with various embodiments of the present invention. In embodiments of the present invention, the output smpᵢ 212 of the first terminal of the capacitor 220 may be coupled to a switch 430. In embodiments of the present invention, the output csmpi 215 of the second terminal of the capacitor 220 may be coupled to a switch 440. In various embodiments, the switches 430 and 440 may each comprise an N-channel transistor and a P-channel transistor connected in parallel. In certain embodiments, switch 430 may comprise a first multiplexer and switch 440 may comprise a second multiplexer. In embodiments of the present invention, the switches 430 and 440 may be controlled by two complementary control signals, a first control signal ˜se1 410 and a second control signal sel 420.

In some embodiments of the present invention, when switches 430 and 440 are turned on by one of the control signals ˜se1 410 or se1 420, a first output smpout and a second output smpout_n from capacitor 220 may be connected to the outputs of the two switches 430 and 440. In certain embodiments, these outputs may then connect be to an operational amplifier, as will be discussed below.

In some embodiments of the present invention, a discharge mechanism 450 may be connected between the first switch 430 and the second switch 440. In certain embodiments, the discharge mechanism 450 may comprise one or more transistors. In certain aspects, capacitor 220 may be discharged by turning switches 430 and 440 on using control signals ˜se1 410 and se1 420 and applying a discharge control 490 to the discharge mechanism 450. In such embodiments, the capacitor 220 may be connected to the discharge mechanism 450 through switches 430 and 440 and when the discharge mechanism is set high the capacitor 220 may discharge through the discharge mechanism 450.

In embodiments of the present invention, when a signal is being stored on capacitor 220 switches 430 and 440 may not be activated and the discharge mechanism may be isolated from the capacitor 220. By isolating the capacitor 220 from the discharge mechanism 450, in various embodiments of the present invention, voltage droop from the capacitor 220 may be prevented and/or reduced.

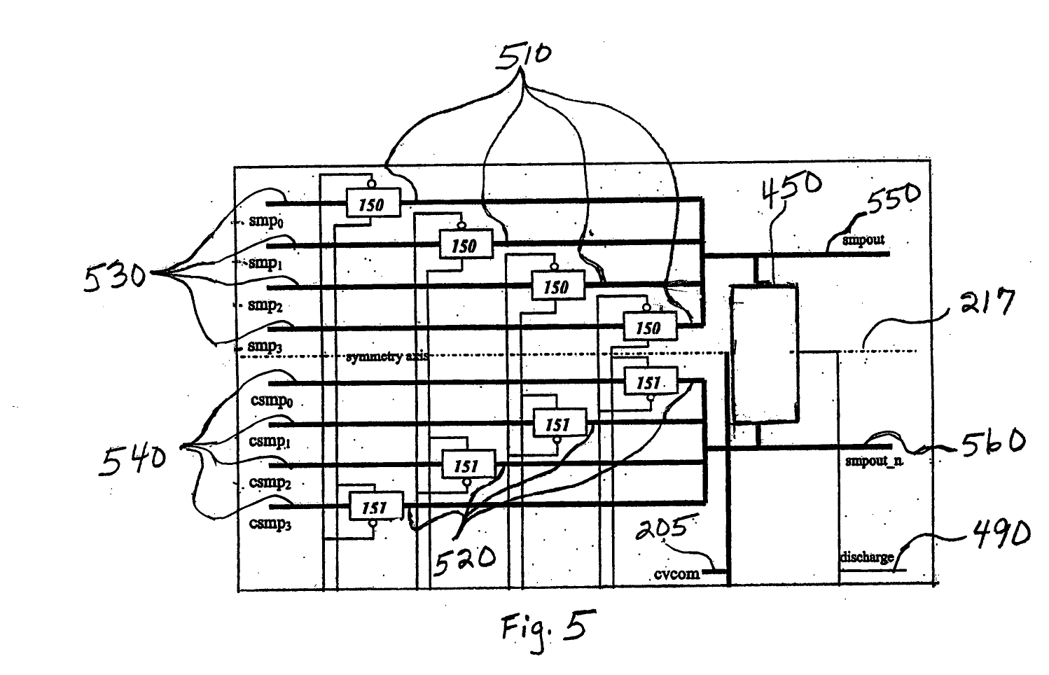

FIG. 5 illustrates a discharge circuit for multiplexing outputs from a sample and hold circuit, in accordance with various embodiments of the present invention. As persons familiar with the art will be aware, FIG. 5, essentially, discloses the same circuitry configuration as FIG. 4, but instead of a single sample and hold circuit, FIG. 5 illustrates the multiplexing of a plurality of sample and hold circuits. In certain embodiments of the present invention, multiple sample and hold circuits may be multiplexed together. As shown in FIG. 5, in certain embodiments of the present invention, four sample and hold circuits, not shown, may be multiplexed using four multiplexers. In embodiments of present invention, outputs 530 from first terminals of hold capacitors in each of the four sample and hold circuits may be applied to a first multiplexer 510. Similarly, in certain aspects, outputs 540 from second terminals of the hold capacitors in each of the four sample and hold circuits may be applied to a second multiplexer 520. In certain embodiments, the discharge mechanism 450 may be associated with both the first multiplexer 510 and the second multiplexer 520.

In various embodiments, the first multiplexer 510 and the second multiplexer 520 may be positioned symmetrically around the symmetry axis 217. As discussed above, symmetrical positioning of electrical components in the multiplexing circuit may provide for load balancing on the two terminals of the hold capacitors in the sample and hold circuits. In some embodiments, balancing of electrical properties of components in communication with the terminals of the hold capacitors may provide for load matching. In various embodiments, the discharge mechanism 450 may only be connected to a hold capacitor in a sample and hold circuit when the capacitor is to be discharged. This, unlike discharge configurations described in references concerning sample and hold circuits, may prevent leakage to ground from the terminals of the capacitors. In various embodiments, the multiplexing circuit 500 may provide for serially producing an output smpout 470 and an output smpout_n 480 from multiple the terminal of hold capacitors in multiple sample and hold circuits. In certain embodiments, the first multiplexer 510 and the second multiplexer 420 may be controlled to select the sample and hold output to be processed.

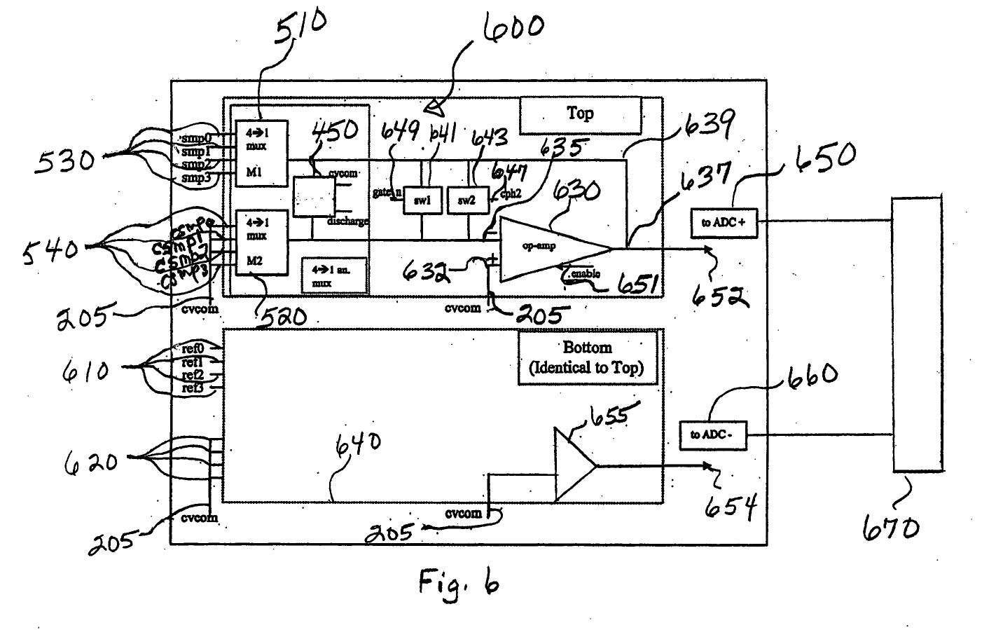

FIG. 6 illustrates an amplification circuit 600 for amplifying an output from a sample and hold circuit, in accordance with various embodiments of the present invention. In embodiments of the present invention, output signals from multiple sample and hold circuits may be fed to an operational amplifier 630 through the first multiplexer 510 and the second multiplexer 520. In some embodiments, an operational transconductance amplifier may be used as the operational amplifier 530. In other embodiments, various different types of operational amplifiers may be used as operational amplifier 530. As discussed above, in certain aspects, the first multiplexer 510 may comprise switch 430 and the second multiplexer 520 may comprise switch 440. In certain embodiments of the present invention, the discharge circuit 450 may be connected between the first multiplexer 510 and the second multiplexer 520.

In embodiments of the present invention, an smpᵢ signal selected form the group of smpᵢ signals 530 may be routed through the first analog multiplexer 510 to the output 637 of the operational amplifier 630. In such embodiments, the common terminal signal csmpi from the group of common terminal signals csmpi 540 related to the selected input smpᵢ signal may be routed to the negative input 635 of the operational amplifier 630. Merely by way of example, when smp₂ is selected and routed through the first multiplexer 510 to the output 637 of the operational amplifier 630, corresponding common terminal signal csmp₂ may be selected and routed to the negative input 635 of the operational amplifier 630. Further, in these embodiments, the positive input 632 of the operational amplifier 530 may be held at the common voltage cvcom 205. In various embodiments, the operational amplifier 630 may work in a closed loop and the negative input 635 may, as a consequence, be at virtual ground. In embodiments of the present invention, the negative input 635 may be at the common voltage cvcom 205 and, as a result, the output 652 of the operational amplifier 630 may settle to the value of smpᵢ. In such embodiments, the configuration of the operational amplifier 630 may provide that the accuracy of the output from the sample and hold circuit does not depend on the value of capacitor 220 or on matching of capacitor pairs.

In various embodiments of the present invention, a feedback loop 639 of the operational amplifier 630 may be closed by: (1) a first switch sw1 541; a second switch sw2 543; and/or by the capacitor 220 via the first multiplexer 510 and the second multiplexer 520. In various embodiments, the second switch sw2 643 may be controlled by a signal cph2 647. In certain aspects, the signal cph2 647 may be used to activate the second switch sw2 643 when the first analog multiplexer 510 switches between its inputs. In this way, control signal cph2 647 may ensure that the-operational amplifier may be in closed loop operation when the first multiplexer 510 switches between inputs. In certain aspects the first switch sw1 641 may be controlled by a signal gate_n 649. In aspects of the present invention, the signal gate_n 649 may activate the switch sw1 541 when the operational amplifier 630 is not in use. In some embodiments of the present invention, an enable control 651 associated with the operational amplifier 630 may be used to provide that no power will be consumed by the operational amplifier 530 when the operational amplifier 630 is not in use. In certain aspects, the enable control 651 may disenable the operational amplifier 530 when the operational amplifier 630 is not in use. In certain aspects, the enable control 651 may be activated to enable the operational amplifier 630 a certain amount of time before an output from a sample and hold circuit capacitor, not shown, may be applied to the operational amplifier 630 to allow the operational amplifier 630 enough time to stabilize.

In some embodiments of the present invention, a second amplification circuit 640 may be provided with the same configuration as the first amplification circuit 600. In certain aspects, refᵢ signals 610, discussed in FIG. 3 above, and crefᵢ signals 620, also discussed in FIG. 3 above, may be routed to a second operational amplifier 655. In some embodiments of the present invention, the output 652 from the first operational amplifier 630 may be connected to a positive input 650 of an analog to digital converter 670 and a second output 654 from the second operational amplifier 635 may be connected to a negative input 660 of the analog to digital converter 570. In certain embodiments of the present invention, pairs of outputs from amplification circuits identical to amplification circuits 600 and 640 may be multiplexed through a multiplexer, not shown in the diagram, to the analog to digital converter 670. In certain aspects, as described in FIG. 1, N/8 operational amplifiers may provide outputs to an N/8→1 analog multiplexer, not shown in FIG. 5, that may route the outputs from the N/8 operational amplifiers to the analog to digital converter 570. As discussed above, embodiments of the present invention may provide for the use of different numbers and ratios of storage and hold circuits, operational amplifiers, multiplexers and analog to digital converters.

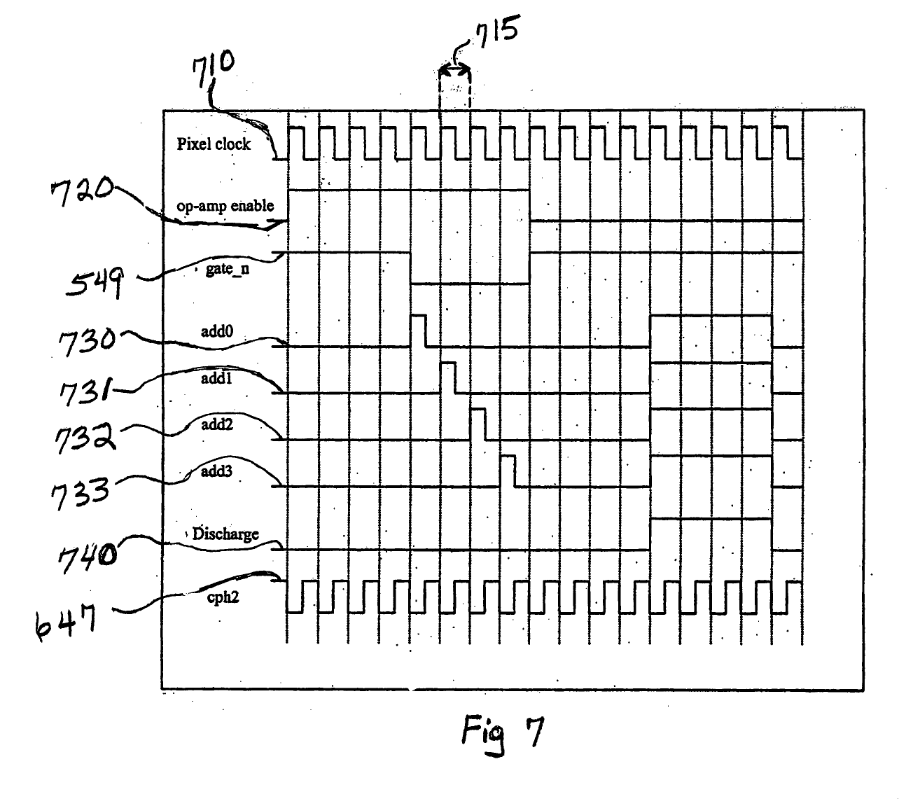

FIG. 7 illustrates timing waveforms of the main control signals of an image sensor device, in accordance with various embodiments of the present invention. In some embodiments, a pixel clock waveform 710 may be used to control and/or provide timing for other image sensor control signals. In certain aspects, a pixel-clock period may represent a period during which an output from a pixel on the image sensor array 100 may be scanned. In embodiments of the present invention, the operational amplifier 630 may be enabled for eight pixel-clock periods, as shown by the op-amp enable waveform 720. In certain aspects, as discussed above, the operational amplifier 630 may be activated for four pixel clock periods before the operational amplifier 630 may be needed, in order to provide for stabilization of the operational amplifier 630. In some embodiments, the gate_n 649 may close the first switch sw1 641 when the operational amplifier 630 is being stabilized to provide that the feedback loop 639 of the operational amplifier 630 may be closed when it is being stabilized so that the operational amplifier 630 is not in cut-off or saturation when it is needed.

In certain embodiments, four control signals—control signal add0 730, control signal add1 731, control signal add2 732 and control signal add3 733 may be used as control signals for the first multiplexer 510 and the second multiplexer 520. In certain embodiments, the four decoded address-lines may be used to control the first and second multiplexers so as to connect the capacitor 220 and the other capacitors connected to the first and second multiplexers to the feedback of the operational amplifier 630. In various embodiments, when none of four control signals is active, signal cph2 647 may be activated to provide that the feedback of the operational amplifier 630 is never disconnected for a long period of time. In some embodiments, discharge signal 740 may be applied for several pixel clock periods after control signal add3 733 is activated to discharge the capacitor 220. In certain embodiments, all of the control signals add0 through add3 may be opened for a period of four clock cycles before the discharge control signal 740 to provide that the discharge of four capacitor pairs, such as the capacitor pair of the capacitor 220 and the capacitor 230, may be discharged in preparation for the reading of the next row of light-sensitive elements on the image array sensor. In further embodiments with a different number of capacitors or capacitor pairs multiplexed to the operational amplifier, different pixel clock periods may be used to provide for discharge of all of the capacitors associated with the operational amplifier.

According to some embodiments of the present invention, the control signals to the analog multiplexers—the control signal add0 730, the control signal add1 731, the control signal add2 732 and the control signal add3 733—may be pulse-shaped. In certain aspects, the feedback control signal cph2 547 may also be pulse-shaped. In various embodiments of the present invention, the use of pulse-shaped control signals and pulse-shaped feedback signals may provide that there is no overlap between the two different signals.

While the principles of the disclosure have been described above in connection with specific apparatuses and methods, it is to be clearly understood that this description is made only by way of example and not as limitation on the scope of the invention.

1. An imager, comprising:
an image sensor;
a sample and hold circuit, comprising:
a first switch coupled to the image sensor and operable to receive an output signal from the image sensor;
a second switch associated with the first switch and operable to receive a common signal; and
a capacitor, wherein,
a first terminal of the capacitor is coupled with the first switch and a second terminal of the capacitor is coupled with the second switch, and
when the first switch and the second switch are open a first-load on the first terminal of the capacitor is matched to a second load on the second terminal of the capacitor; and
an analog to digital converter coupled to the capacitor and operable to receive an analog signal from the first capacitor and convert the analog signal into a digital signal.

2. The imager of claim 1, further comprising:
a discharge mechanism coupled to the capacitor and operable to discharge the capacitor.

3. The imager of claim 1, wherein:
the image sensor is a CMOS image sensor.

4. The imager of claim 1, wherein:
the first switch comprises a first N-channel transistor and a first P-channel transistor connected in parallel; and
the second switch comprises a second N-channel transistor and a second P-channel transistor connected in parallel.

5. The imager of claim 1, wherein:
the output signal is the output of a pixel on the image sensor, and
the analog signal is equivalent to the difference between the output signal and the common signal.

6. The imager of claim 1, wherein:
the first and the second switch are positioned substantially equidistant from a symmetry axis that passes between the first and the second switch; and
the first and the second terminal are positioned on opposite sides of and substantially equidistant from the symmetry axis.

7. An imager, comprising:
an image sensor;
a sample and hold circuit, comprising:
a first switch coupled to the image sensor and operable to receive an output signal from the image sensor;
a second switch associated with the first switch and operable to receive a common signal;
a third switch coupled to the image sensor and operable to receive a second output signal from the image sensor;
a fourth switch associated with the third switch and operable to receive the common signal; and
a first capacitor, wherein,
a first terminal of the first capacitor is coupled with the first switch and a second terminal of the first capacitor is coupled with the second switch, and
when the first and second switch are open a first load on the first terminal of the capacitor is matched to a second load on the second terminal of the capacitor;
a second capacitor, wherein,
a first terminal of the second capacitor is coupled with the third switch and a second terminal of the second capacitor is coupled with the fourth switch, and
when the third and fourth switch are open a first load on the first terminal of the second capacitor is matched to a second load on the second terminal of the second capacitor; and
an analog to digital converter coupled to the first and second capacitors and operable to receive analog signals from the first and second capacitors and convert the analog signals into digital signals.

8. The imager of claim 7, further comprising:
a first discharge mechanism coupled to the first capacitor for discharging the first capacitor, and
a second discharge mechanism coupled to the second capacitor for discharging the second capacitor.

9. The imager of claim 7, wherein:
the image sensor is a CMOS image sensor.

10. The imager of claim 7, wherein:
the first, second, third and fourth switches each comprise an N-channel transistor and a P-channel transistor connected in parallel.

11. The imager of claim 7, wherein:
the first output signal is the output of a pixel on the image sensor when the pixel is illuminated, and
the second output signal is the output of a pixel on the image sensor when the pixel is reset.

12. The imager of claim 7, wherein:
the first and the second switch are positioned substantially equidistant from a symmetry axis that passes between the first and the second switch,
the third and the fourth switch are positioned on opposite sides of and substantially equidistant from the symmetry axis,
the first and the second terminals of the first capacitor are positioned on opposite sides of and substantially equidistant from the symmetry axis, and
the first and the second terminals of the second capacitor are positioned on opposite sides of and substantially equidistant from the symmetry axis.

13. An imager, comprising:
an image sensor;
a capacitor coupled to the image sensor and operable to receive and store an analog output signal from the image sensor;
a first switch coupled to a first terminal of the capacitor;
a second switch coupled to a second terminal of the capacitor;
an analog to digital converter coupled to the first and second switch operable to convert the analog output signal to a digital signal; and
a discharge mechanism coupled to the first and second switches and operable to discharge the capacitor, wherein
the discharge mechanism is connected to the capacitor when the first and second switch are closed, and
the discharge mechanism is not connected to the capacitor when the first and second switch are open.

14. The imager of claim 13, further comprising:
a common signal source;
a third switch coupled to the image sensor and the first terminal;
a fourth switch coupled to the common signal source and the second terminal, wherein
the first, second, third and fourth switch are electrically matched, and
the load on the first terminal is substantially equivalent to the load on the second terminal.

15. The imager of claim 13, further comprising:
a common signal source, wherein the common signal source is coupled to the second terminal; and
an operational amplifier, wherein
the output of the operational amplifier is coupled to the first switch and to the analog to digital converter,
the negative input of the operational amplifier is coupled to the second switch, and
the positive input of the operational amplifier is coupled to the common signal source.

16. The imager of claim 13, wherein
the discharge mechanism is a transistor operable to discharge the capacitor when the first and second switches are closed and the transistor is set to high.

17. A method for sampling and holding a signal from an image sensor, comprising:
outputting the signal from the image sensor through a first switch to a first terminal of a capacitor;
providing a common signal to a second terminal of the capacitor through a second switch;
providing that a first load on the first terminal and a second load on the second terminal match;
opening the first and the second switch; and
storing an analog signal on the capacitor, wherein the analog signal is the difference between the signal from the image sensor and the common signal.

18. The method for sampling and holding the signal from the image sensor as recited in claim 17, further comprising:
providing a third switch that is coupled to the first terminal;
providing a fourth switch that is coupled to the second terminal;
coupling an analog to digital converter to the capacitor through the third and fourth switches;
closing the third and fourth switches;
receiving the analog signal at the analog to digital converter; and
converting the analog signal to a digital signal.

19. The method for sampling and holding the signal from the image sensor as recited in claim 17, further comprising:
providing a third switch that is coupled to the first terminal;
providing a fourth switch that is coupled to the second terminal;
providing a discharge mechanism that is coupled to the third and the fourth switch;
connecting the discharge mechanism to the capacitor; and
using the discharge mechanism to discharge the capacitor.

20. The method for sampling and holding the signal from the image sensor as recited in claim 17, further comprising:
providing a third switch that is coupled to the first terminal;
providing a fourth switch that is coupled to the second terminal;
providing an analog to digital converter; and
providing an operational amplifier, wherein
the output of the operational amplifier is coupled to the third switch and to the analog to digital converter,
the negative input of the operational amplifier is coupled to the fourth switch, and
the positive input of the operational amplifier is coupled to the common signal.

21. The method for sampling and holding the signal from the image sensor as recited in claim 17, further comprising:
providing a third switch that is coupled to the first terminal;
providing a fourth switch that is coupled to the second terminal;
providing an analog to digital converter;
providing an operational amplifier, wherein
the output of the operational amplifier is coupled to the third switch and to the analog to digital converter;
the negative input of the operational amplifier is coupled to the fourth switch, and
the positive input of the operational amplifier is coupled to the common signal; and
using pulse shaped control signals to control the third and fourth switches; and
using a pulse shaped feedback control signal to control feedback of the operational amplifier.
